(19) United States
(12) Patent Application Publication
(10) Pub. No.: US 2024/0111601 A1
(43) Pub. Date: Apr. 4, 2024

(54) ENHANCED MIGRATION OF OBJECTS AMONG COMPUTING ENVIRONMENTS

(71) Applicant: MicroStrategy Incorporated, Vienna, VA (US)

(72) Inventors: Yingchun Mei, Hangzhou City (CN); Xin Liu, Hangzhou City (CN); Xiaoqin Jin, Hangzhou City (CN)

(21) Appl. No.: 17/956,220

(22) Filed: Sep. 29, 2022

(51) Int. Cl. G06F 9/50; G06F 8/41; G06F 8/65

(52) U.S. Cl. CPC G06F 9/5072; G06F 8/433; G06F 8/65; G06F 9/5077; G06F 9/5088

(57) ABSTRACT

Methods, systems, and apparatus, including computer programs encoded on computer-storage media, for enhanced migration of objects among computing environments. In some implementations, a system provides a first interface for creating packages of data objects and receives input data through the first interface specifying (i) data objects to include in a first data package, and (ii) a destination computing environment to receive the first data package. The system generates the first data package and stores the first data package in a repository in cloud computing data storage. The system provides a second interface for monitoring and acting on requests to deploy data packages to computing environments. In response to receiving approval through the second interface to deploy the first data package to the destination computing environment, the system causes the first data package to be deployed to the destination computing environment from the repository in cloud computing data storage.

### BACKGROUND

The present specification relates to architectures for managing computer systems, including enterprise computer systems. Enterprise systems often include multiple computing environments, which may be hosted on premises or in cloud computing infrastructure. The various computing environments often use different combinations of software, documents, data, and other content to meet the needs of different groups of users.

### SUMMARY

In some implementations, a computer system provides functionality to manage and transfer the objects that are used and available for different computing environments. For example, the system can provide an object manager that enables users to create packages of data objects and migrate the packages to computing environments. When creating the packages, the system can identify dependencies among data objects, and can include in the packages the software, documents, metadata, and other items needed to meet the dependencies. The system can also store created packages in a repository in cloud computing infrastructure, enabling the packages to be deployed with high efficiency to any of various computing environments.

Enterprises often provide multiple computing environments, which may use different systems, servers, namespaces, domains, and so on. To ensure security and proper operation, many computing environments are managed and updated separately, with the software and data needed for each computing environment determined for the function or users of the environment. For example, different divisions of a company may use different web server environments tailored to their particular needs. Similarly, an application server environment, database server environment, and web server environment may each use different versions of software (e.g., different build versions) and different combinations of software packages as needed for their respective functions. These different computing environments may access different databases, data sets, sets of documents, and so on.

Security procedures often prohibit most users from making changes to computing environments, because improper changes can impair a system and may be difficult to find and reverse. However, the users of a computing environment are often in the best position to know what functionality and data is needed, and disallowing changes by users can prevent important changes that are needed for computing environments to meet the needs of the users.

The present system can provide interfaces that provide increased control and management functionality to users generally, while maintaining the security of the enterprise computing system. To do this, the system can provide interfaces that present different levels of management and migration functionality to different types of users. For a general category of users, the user interfaces can include controls to create packages of objects and to request migration of the packages to computing environments. The user interfaces may show users the packages that they create and the status of their migration requests, while hiding information about other packages and migration requests (e.g., from other users or from other departments of their organization). For users in an administrator category or which have the appropriate permissions, the user interfaces may include controls for administrators to view, edit, and approve or deny migration requests. The administrator interface can also provide additional tools to validate or test requested migrations before granting approval, and to also track previous packages migrated and to reverse the migrations if desired. The administrator interface can also include status information across all of the computing environments that the administrator has permissions to manage.

The system can maintain a cloud computing based repository of data packages created by users, as well as maintain a queue of migration requests to deploy specific packages to specific destination computing environments. Based on the queue of migration requests and associated information, the system can provide status information to the users that request the migrations as well as the administrators having responsibility for the computing environments. In some implementations, the status information is provided in a web-based interface or through notifications, alerts, or other messages provided as status changes (e.g., when a new migration request is entered, when the migration request is approved or denied, when the requested migration is completed, etc.).

In one general aspect, a method performed by one or more computers includes: providing, by the one or more computers, a first interface for defining packages of data objects; receiving, by the one or more computers, input data from a first user through the first interface, wherein the input data specifies (i) data objects to include in a first data package, and (ii) a destination computing environment to receive the first data package; generating, by the one or more computers, the first data package and storing the first data package in a repository in cloud computing data storage; providing, by the one or more computers, a second interface for monitoring and acting on requests to deploy data packages to computing environments; and in response to receiving approval from a second user through the second interface to deploy the first data package to the destination computing environment, causing, by the one or more computers, the first data package to be retrieved from the repository in cloud computing data storage and to be deployed to the destination computing environment.

In some implementations, providing the first interface comprises providing an application programming interface (API) or providing user interface data for a user interface presented at a client device of the first user. Providing the second interface comprises providing an API or providing user interface data for a user interface presented at a client device of the second user.

In some implementations, generating the first data package comprises: retrieving the data objects indicated through the first interface from one or more repositories or source computing environments; identifying a second data objects as dependencies of the data objects; based on identifying the second data objects as dependencies of the data objects, retrieving the second data objects; and generating the first data package to include the retrieved data objects indicated through the first interface and the retrieved second data objects.

In some implementations, the method includes maintaining a records of package deployment requests and storing, for each migration request, an indication of a data package to be deployed, a target computing environment to receive the data package, an identifier for a user that requested deployment of the data package to the target computing environment, and a status of the requested deployment.

In some implementations, providing the second interface comprises providing user interface data listing deployment requests initiated by different users and current status of each of the deployment requests, wherein a list of deployment requests is presented with user interface controls for the second user to select whether to approve or deny the deployment requests.

In some implementations, the method includes providing the second interface comprises providing indications of current status of each of multiple deployment requests, including a measure of completion of at least one deployment in progress.

In some implementations, providing the second interface comprises providing user interface data indicating a completed deployment request that has been fulfilled by deployment of a particular data package to a particular computing environment, the completed deployment request being presented with one or more user interface controls that are selectable by the second user to cause the one or more computers to reverse the deployment of the particular data package to the particular computing environment.

In some implementations, the first user and the second user are assigned different permissions for managing deployment of packages, wherein the first user has permissions to create data packages and request deployment of data packages but not to perform deployment of data packages, and wherein the second user has increased permissions that include authorization to view and approve or deny deployment requests made by other users, wherein content provided through the first interface and the second interface is determined based on the respective permissions of the first user and the second user.

In some implementations, the first user and the second user are assigned different permissions for managing deployment of packages, wherein the first user has permissions to view deployment requests by the first user and status of the deployment requests by the first user but not to view deployment requests by other users, and wherein the second user has increased permissions that include authorization to view and approve or deny deployment requests made by other users, wherein content provided through the first interface and the second interface is determined based on the respective permissions of the first user and the second user.

In some implementations, providing the second interface comprises providing a validation control that is selectable by the second user to initiate validation analysis for the first data package. The method comprises: receiving input data indicating selection of the validation control by the second user; in response to receiving the input data, assessing compatibility of the first data package with the destination computing environment; and providing, through the second interface, results of assessing the compatibility of the first data package with the destination computing environment.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1B are diagrams showing an example of a system for managing migration of objects among computing environments.

FIG. 2 is diagram illustrating an example of a user interface for managing object migration among computer environments.

FIGS. 3A-31 are diagrams illustrating examples of user interfaces for creating object packages and for requesting and managing deployment of object packages.

Like reference numbers and designations in the various drawings indicate like elements.

### DETAILED DESCRIPTION

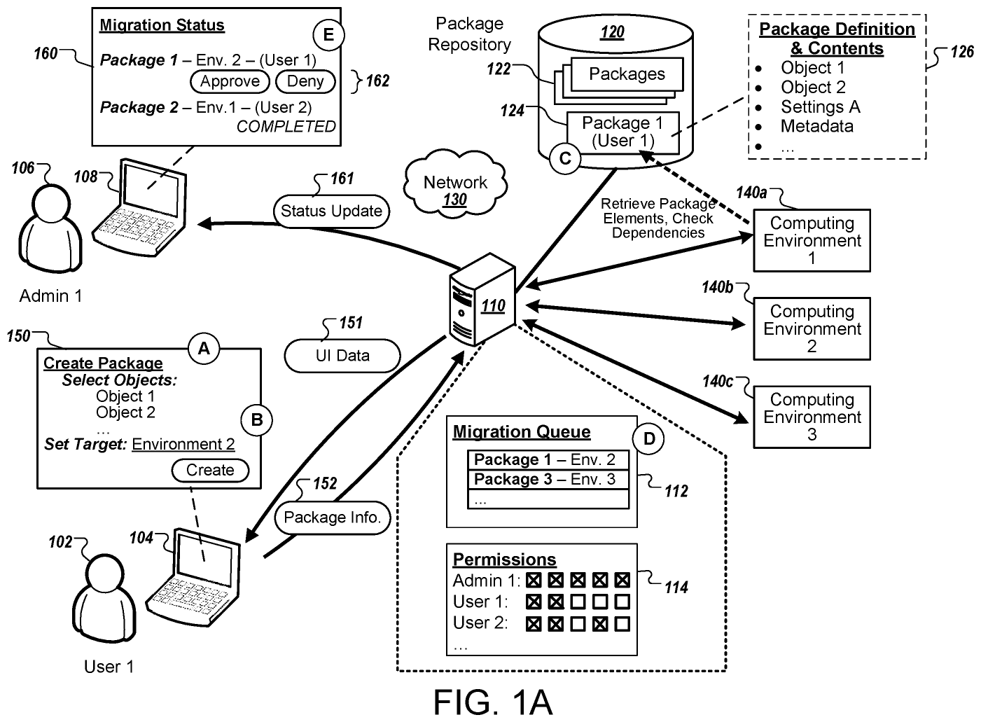

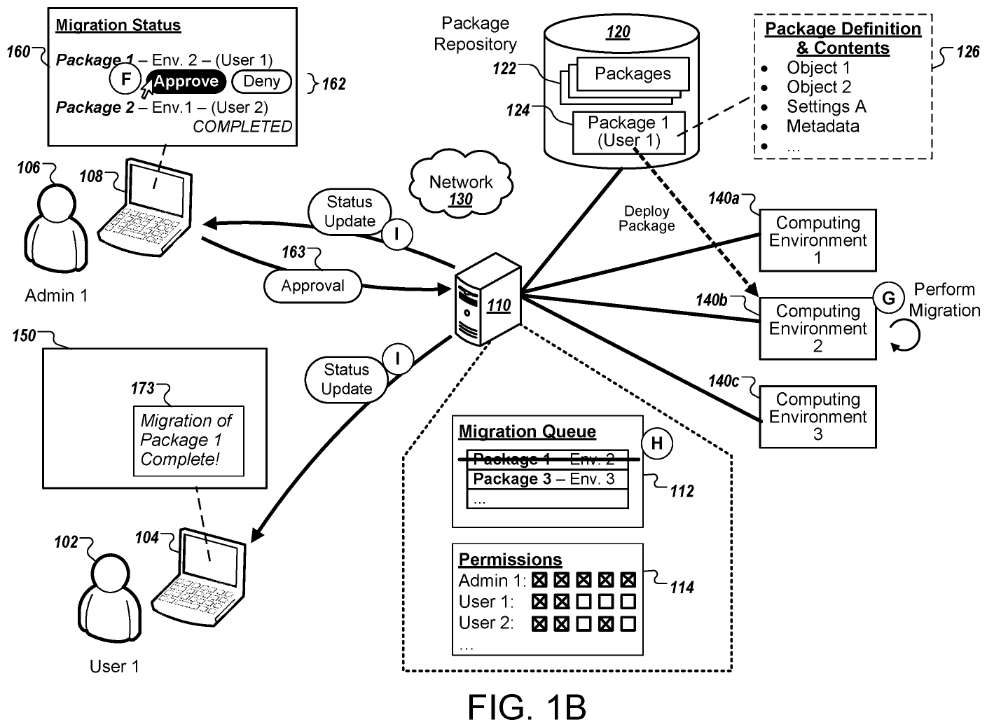

FIGS. 1A-1B are diagrams showing an example of a system 100 for managing migration of objects among computing environments. The system 100 includes a computer system 110 that provides functionality to facilitate creation and deployment of packages of objects to computing environments. The computer 110 communicates with client devices 104, 108 over a communication network 130 and provides interfaces for users to define packages, set deployment destinations, and view package deployment status. The computer system 110 stores packages in a repository 120, which can be stored in cloud computing data storage. When a request for deploying a package is approved by an administrator (e.g., a user with sufficient permissions to approve the action), the computer system 110 causes the objects in the package to be deployed to the appropriate computing environment(s) 140a-140c.

As an overview, FIGS. 1A-1B show interactions and processing represented as a series of stages (A) to (I). The operations represented in these stages may be performed in the order indicated or in a different order.

Briefly, FIG. 1A shows the computer system 110 providing a first interface that a user 102 of a client device 104 uses to specify objects to include in a data package 124 and to specify a destination computing environment 140b to receive the data package 124. The computer system 110 retrieves the objects specified by the user 102, and then creates and stores the data package 124 in a cloud-computing-based package repository 120. The user 102 does not have the permissions needed to make changes to the selected destination computer system 110, so the computer system 110 enters the migration as a requested migration action. The computer system 110 also provides a management interface for a second user 106 that has the permissions to be able to approve the migration request. FIG. 1B shows that the user 106 approves the migration request, and the computer system 110 coordinates deployment of the package 124 to the destination computing environment 140b. The computer system 110 then provides status updates or notifications to the users 102, 106, for example, to indicate when the progress of the migration and to indicate when the migration is completed.

In further detail, the computer system 110 can be a server system implemented using on premises computing equipment, remote computing equipment (such as a data center), or cloud computing infrastructure. In the illustrated example, the computer system 110 represents a management server, hosted by a cloud computing system, that supports management of three computing environments 140a-140c of an organization. For simplicity, the users and computing environments for a single organization are shown. Nevertheless, the computer system 110 can be configured to support users of multiple different organizations to manage the computing environments of the respective organizations. For example, the computer system 110 may act as a multi-tenant system to provide management interfaces for the users and computing environments of different organizations. As another example, different instances of the computer system 110 can be run as cloud computing environments or as on-premises server environments, so each instance supports a different organization.

The computer system 110 can store information indicating the identities and permissions of authorized users. Different users can be assigned permissions for different sets of actions. For example, some users can be permitted to create data packages and to request migration of the data packages, but are not permitted to carry out the migration. Other users can have permission to act on requested migrations and choose whether to approve or deny requested changes.

The network 130 can include one or more public or private networks, which can include the Internet. The computer system 110 can provide interfaces and can manage computing environments 140a-140c over a local area network, a wide area network, or other types of networks.

The users 102, 106 each interact with a corresponding client device 104, 108, such as a smart phone, laptop computer, tablet computer, desktop computer, etc. The client devices 104, 108 can have a software application installed that communicates with the computer system 110 to provide various user interfaces and controls. In addition, or as an alternative, the client devices 104, 108 may provide the user interfaces through a web browser, and the computer system 110 can provide content for the user interface as a web page, web application, or other network-based resource.

In stage (A), the client device 104 presents a user interface 150 for creating a new package of objects. The interface 150 may similarly be used to edit an existing package of objects. The computer system 110 can send user interface data 151 to the client device 104 over the network 130. The user interface data 151 may be provided in the form of a web page, content of a web application, content provided to a native application running on the client device 104, or in another manner.

The user 102 has logged in and authenticated, and the computer system 110 tailors the content of the user interface 150 for the permissions and role of the user 102. The computer system 110 stores permissions 114 for the various users of the system, to adjust the content presented and the management actions that are available to each user. For example, the interface 150 can limit access to documents and datasets that the user 102 has permission to access. In addition, status information about data packages and migration requests can be limited to the packages and requests made by the user 102. As another example, the user 102 may have permissions to view packages and requests of a certain set of other users (e.g., other users in a group or department within the user's organization), or to view packages or requests involving specific computing environments. In the example, the user 102 does not have permissions to actually carry out migration of objects to the destination computing environments and is blocked from doing so by the system. For example, the user interface 150 may provide controls to create data packages and to request deployment to target computing environments, but may omit or disable controls for actually initiating the deployment.

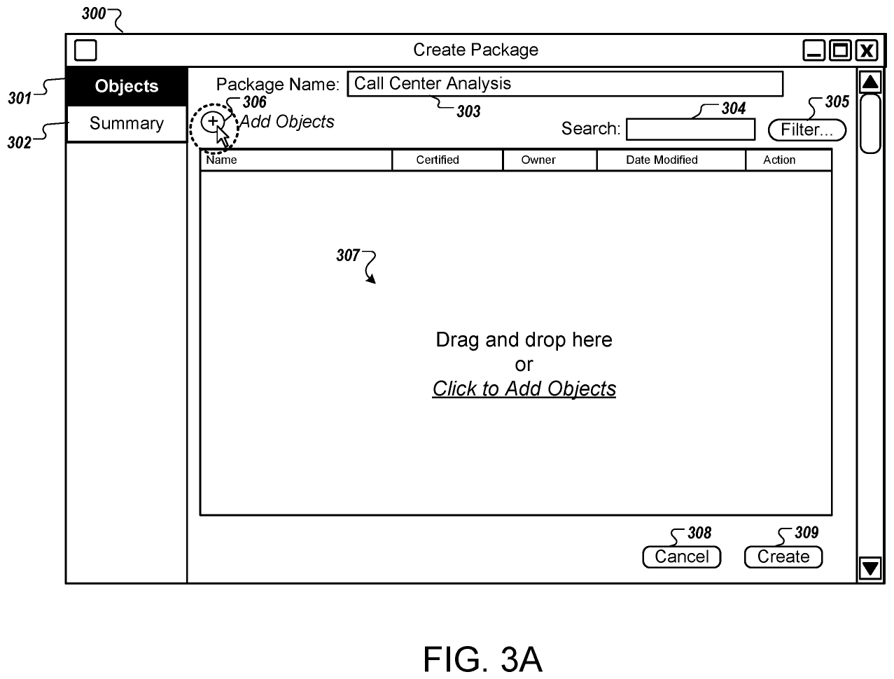

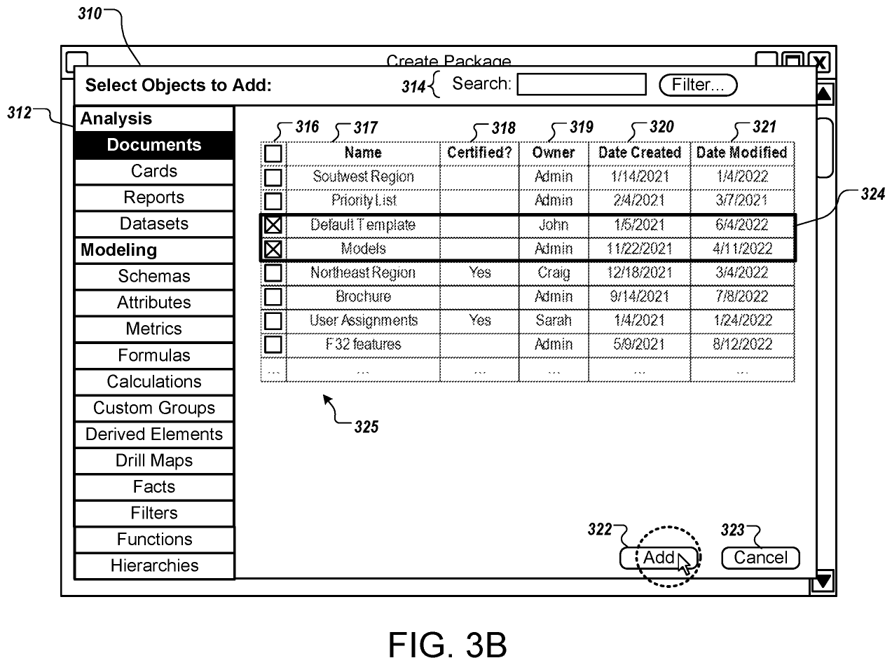

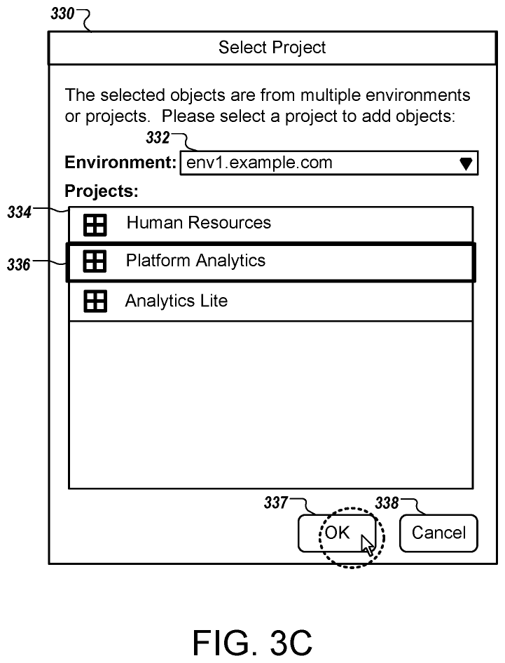

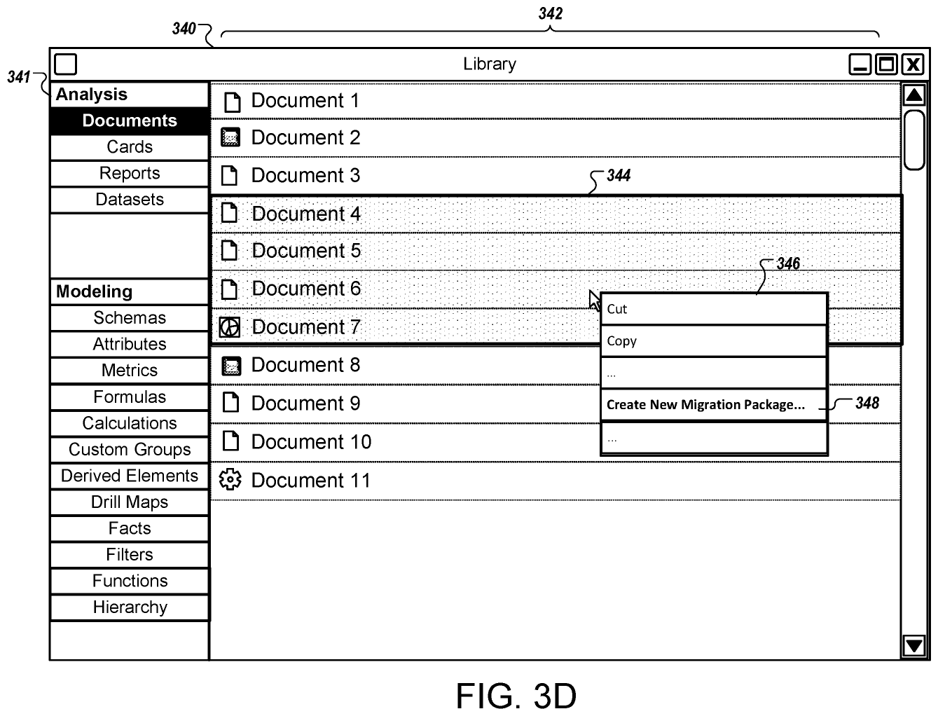

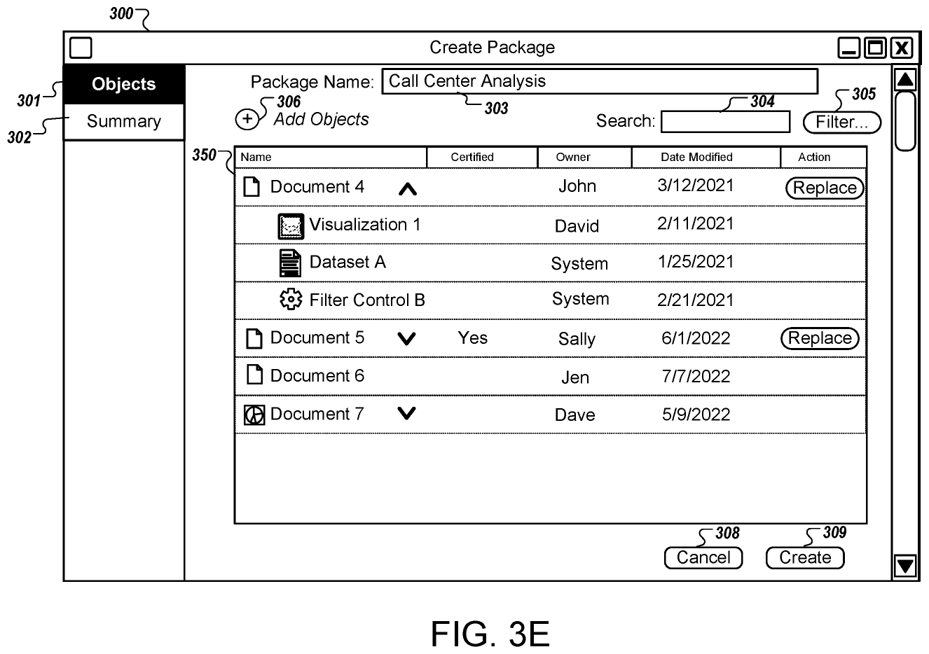

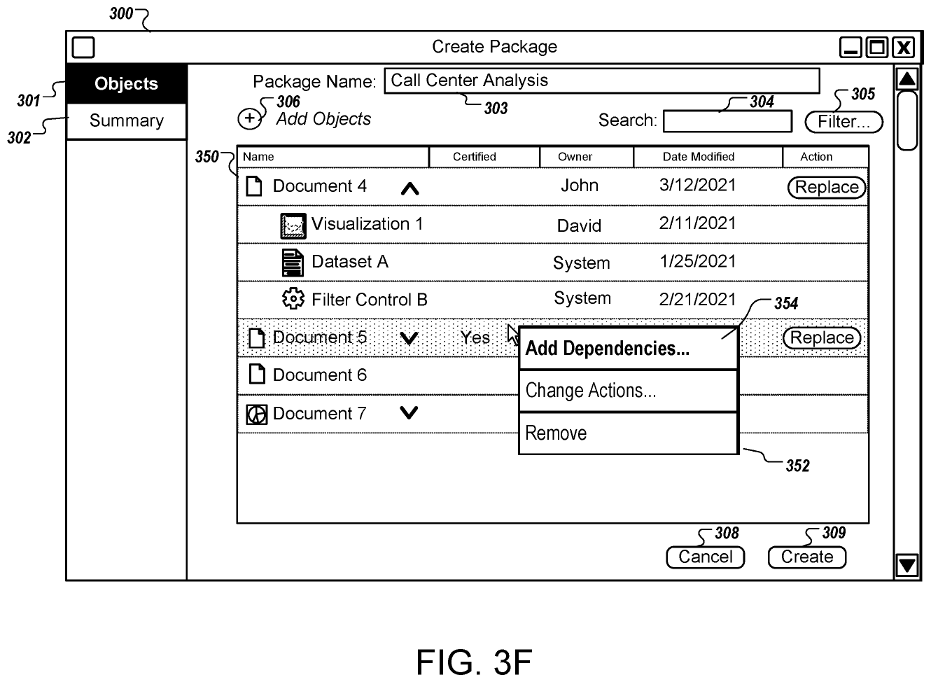

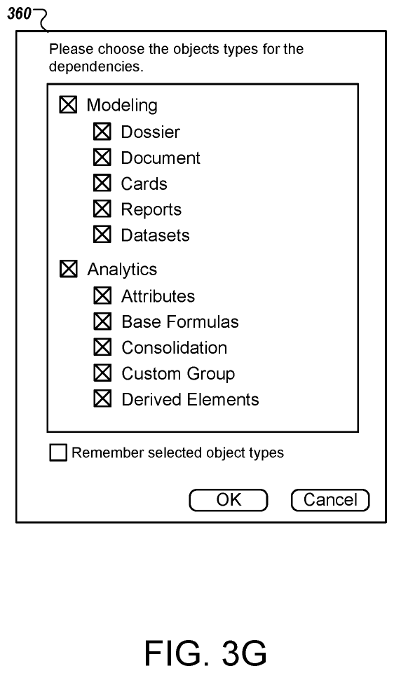

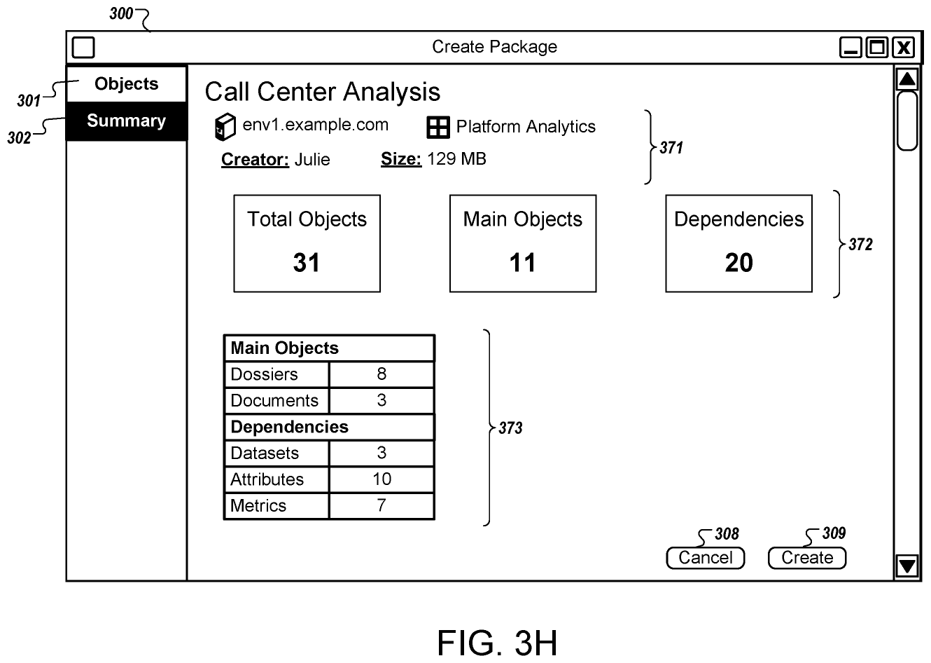

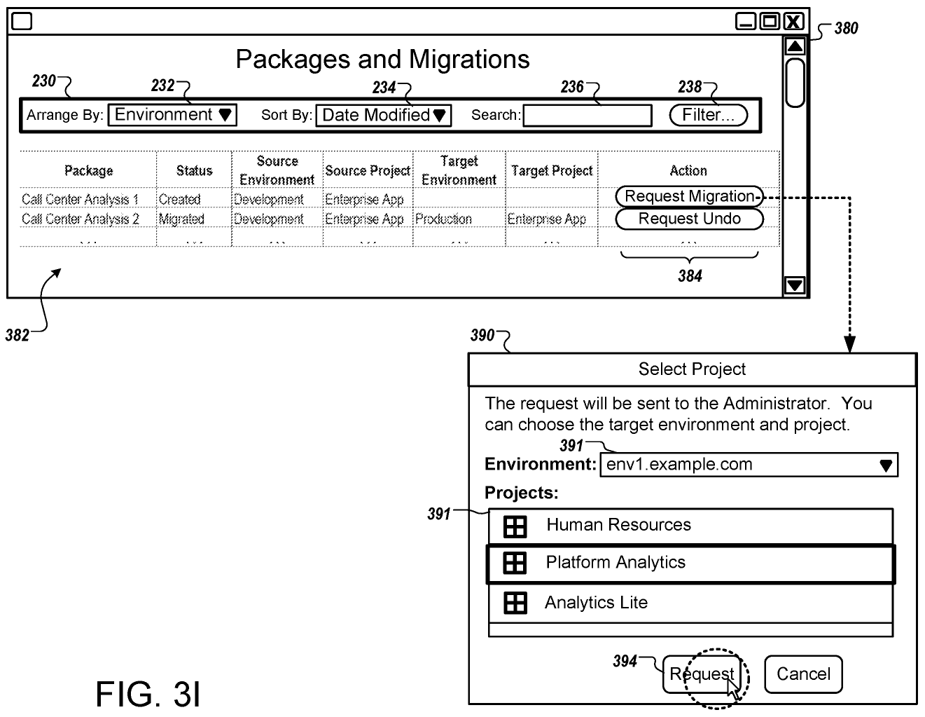

The user 102 uses the user interface 150 to select data objects to include in the data package. Examples of this process are shown in greater detail in FIGS. 3A-31.

Many different types of data objects can be selected, for example, documents, dashboards, datasets, software modules (e.g., applications, library files, executable code, interpretable code, scripts, etc.), metadata, object definitions, database schemas, configuration settings, media (e.g., image files, audio files, video files, etc.), files, and more. The user may select objects by selecting documents from a list of documents in a document library, selecting files from a file system browsing view, selecting icons from a list of data sets, and so on.

In many cases, various data objects may be interrelated. A combination of multiple data objects may be needed to successfully deploy a data object so that it functions properly in the destination computing environment. When a user selects an object to include in a package, the computer system 110 can identify the dependencies needed for the object to be integrated into and be usable in the destination computing environment. For example, the dependencies can be items such as software, data, files, settings, metadata, media, network addresses, permissions or access tokens, and other elements.

Some dependencies may be items referenced by a data object. For example, a document that the user 102 selects may include a reference (e.g., a universal resource identifier (URI), a universal resource locator (URL), network address, file path, hyperlink, etc.) to a resource such as a file or type of data. As another example, a document may include a command that accesses an application programming interface (API) and makes a call (e.g., through a remote procedure call (RPC) or a call using a representational state transfer (REST) API).

In other situations, the dependencies for an object may be implicit and the objects do not include a direct reference to the related item or functionality needed. For example, document may directly reference a dataset, but may not reference a set of metadata or other content needed to use or interpret the dataset. As another example, the user 102 may select an object having a particular file type, encoding, or data format, or which was created according to a particular data schema, encryption scheme, etc. The computer system 110 may identify the appropriate software, format definitions, schemas, encryption parameters, or other elements needed to use an interpret the object the user selected, especially if those elements or capabilities are not part of the default set of functionality for (or actual set of functionality determined to be present at) the destination computing environment. Similarly, the selected objects may involve interaction with devices (e.g., network interface, printers, etc.) or software for which drivers or interface software may be needed.

The computer system 110 can analyze each object that the user 102 selects to include in the data package. This can include analyzing the metadata for the object and extracting dependencies from items specified in the metadata. Similarly, the computer system 110 can use object metadata to determine software or software build versions needed to use the object. If the user 102 selects to include a document that presents images or visualizations, the computer system 110 can include the images and visualizations (and/or data and parameters used to generate the visualizations). The computer system 110 can also analyze the content of each object to identify references (e.g., hyperlinks, URIs, etc.) and API calls referenced in the object, to identify the list of other objects referenced so those can be included as dependencies. The computer system 110 can also use other information about the object (e.g., data format, encryption scheme, database schema used, etc.) to identify other objects, metadata, or other components to use or interpret the objects the user selected. After identifying the dependencies of user-selected objects, the computer system 110 can perform additional iterations of dependency analysis to identify dependencies for the dependencies, each time examining the content and characteristics of items added to the list of items to be included in the data package and determining if any additional dependencies should be added. As a result, for a given user-selected object, the computer system 110 may identify and include items to provide multiple levels of dependencies.

In stage (B), the user 102 specifies a target computing environment 140b as the destination to receive the data package that is being created or edited using the interface 150. As noted above, to use the interface 150, the user 102 logs in and is authenticated by the computer system 110. The content accessible by the user 102 through the interface 150 is limited according to the permissions of the user 102 and the range of content the user 102 is able to access. The computer system 110 can use the permissions of the user 102 to determine which computing environments 140a-140c the user 102 is able to view and select as targets for deploying the data package. For example, the user 102 may have permission to view and select a limited subset of computing environments of the user's organization, such as computing environments associated with projects the user 102 is registered as working on or computing environments in a department or user group the user 102 is a member of. In the illustrated example, the user 102 selects the computing environment 140b as the desired destination for the data package defined using the interface 150.

Once the user 102 has specified the contents for the data package and the desired destination computing environment 140b, the user 102 can select to create the data package and request migration to the destination computing environment 140b. Although the user 102 has permissions to create data packages and to request deployment to at least some computing environments, the user 102 does not have the permissions required to actually carryout the package deployment. The actual deployment requires a greater level of authorization that an administrator (“Admin 1” or user 106) has, which the user 102 does not have. Nevertheless, the computer system 110 and the interface 150 give the user 102 versatile functionality to create customized data packages to be deployed and to set the destinations for those data packages. The requested deployments can be held in a pending state and then performed once a properly authorized user has reviewed and approved.

The package information 152 that the user 102 enters in the interface 150, e.g., the package contents and the destination computing environment 140b, is provided to the computer system 110 over the network 130.

In stage (C), the computer system 110 receives the package information 152, creates the data package specified by the user 102, and stores the resulting data package 124 in the repository 120 in cloud computing data storage. The package information 152 may specify data objects from various different sources, e.g., various projects, databases, document libraries, computing environments, or other sources. In the example, the user 102 has specified objects from the computing environment 140a. As a result, the computer system 110 retrieves the objects (e.g., files, data, software, etc.) that the user 102 specified, along with any dependencies that the computer system 110 identified. In some implementations, items identified as dependencies may be retrieved from other locations, such as a database system, a document library server, a metadata repository, etc. As part of generating the data package 124, the computer system 110 may again evaluate which dependencies are needed and can verify that all objects and needed dependencies are provided. Because the destination computing environment 140b has been specified, the computer system 110 can select from among various versions of objects (e.g., different software build versions, file formats, data encodings, etc.) to include in the data package 124. The computer system 110 can also convert objects, if needed, to provide compatibility with the capabilities and configuration of the destination computing environment 140b.

The computer system 110 assembles the retrieved objects into the data package 124, which can be an archive file or other format containing the files, data, configuration settings, and other elements to be deployed. The contents of the data package 124 are represented as package elements 126. The package 124 can include deployment instructions specifying operations to be performed in order to deploy the package 124. These instructions can be specified in the form of executable code, an interpretable script, a list or sequence of commands, or in another form. The data packages 122, 124 can be stored in the repository 120 even after the currently requested deployment is completed, which facilitates re-use of the data packages 122, 124 to create new data packages or for new deployments, as well as to facilitate comparisons and potentially reversing deployments or repeating a deployment when needed.

The computer system 110 stores the generated data package 124 in the cloud-based package repository 120. The repository 120 can be used to store many different data packages 122, which may be created by different users, departments, or organizations. The computer system 110 can manage access to the various data packages 122, 124 stored to limit the access of each user and organization to the data packages that their permissions enable them to access. By storing the packages in cloud computing storage, the computer system 110 can efficiently deploy data packages to a broad variety of computing environments 140a-140c, including to computing environments hosted on premises by an organization, in a remote data center, or in cloud computing infrastructure. The computer system 110 and the interfaces 150, 160 provide a wide range of management actions over the network 130, including enabling users to access data packages 122, 124, manage deployments, and view current status of deployment requests.

In stage (D), the computer system 110 updates records of deployment requests. The computer system 110 tracks the deployment requests that are made, including recording, for each deployment request, the data package involved, the destination computing environment specified, the user that requested the deployment, and so on. The computer system 110 also tracks the status of the deployment (e.g., requested, approved, denied, in progress and the percentage of completion, etc.). The computer system 110 maintains records of the deployments that are performed even after the deployment is completed, which enables the computer system 110 to reverse the deployments and roll back the changes if needed.

For example, the computer system 110 can have a queue 112 of migration requests that are pending, e.g., package deployments that have been requested by not completed or denied. As new deployment requests are received, the computer system 110 records the information about each deployment request (e.g., storing an identifier for the data package, an identifier for the destination computing environment, an identifier for the user making the request, etc.) and enters an item in the queue 112 to represent the deployment request that still needs to be acted on. The computer system 110 can then use the information in the queue 112 and other records to notify an administrator or other user with the permissions and/or designated role to be able to act on the request. For example, the computer system 110 can use user records and the permissions 114 to determine that the user 106 has the authorization and/or administrator role granting management access for the computing environment 140b, which is the destination specified for the data package 124. As a result, the computer system 110 can send a notification to the user 106 about the deployment request targeting the computing environment 140b, such as in a short message service (SMS) text message, an e-mail, a notification in an application of a mobile device, a notification in a chat interface, an entry or notification on a dashboard or status interface, and so on.

In stage (E), the computer system 110 provides information notifying the user 106 of the requested deployment of the data package 124 to the computing environment 140b. The user 106 accesses a user interface 160 using the client device 108. The user interface 160 may be provided through a web page, web application, a native software application on the client device 108, or in another form. As with the interface 150, the user 106 has logged in and authenticated with the system so that the content of the user interface 160 is tailored for the permissions granted to the user 106, who is an administrator with full permissions to manage the computing environments 140a-140c, including to approve or deny deployment requests for the computing environments 140a-140c.

The user interface 160 presents a list of requested package deployments and the status of each, as indicated by the computer system 110. These can include deployment requests that have been made and are pending, waiting for action by an authorized user (e.g., requests submitted by users but not yet approved or denied by an administrator). The interface 160 can include interactive controls for the user 106 to act on the requests. For example, for the request to deploy the data package 124 is shown along with user interface controls 162 enabling the user 102 to select whether to approve or deny the request. As illustrated, the user interface 160 can also list other deployment requests that have been acted on and the status of each. For example, other deployment requests may be shown as completed, approved and in progress, or denied.

The interface 160 can include additional functionality discussed further below, such as functionality to view contents of data packages, to edit data packages and migration requests, to validate data packages (e.g., to test compatibility, verify completeness and authenticity of package contents, etc.), to reverse deployment of packages already deployed, and so on. The interface 160 can also include features to enable the user 106 to filter the sets of deployment requests that are shown, for example, by date submitted, by status of the deployment request, by user submitting the data package, by data package size, by computing environment targeted as the destination, by contents of the data packages, and so on.

Although the interface 160 that lists deployment requests and status is shown being provided to the user 106, a version of the interface 160 can also be provided to the user 102. Because the permissions of the user 102 are more limited than those of the user 106, however, the set of deployment requests shown and the set of options shown may be different. For example, rather than showing a list of all deployment requests for the computing environments 140a-140c, the user 102 may be shown only the set of deployment requests that the user 102 has made, or the set of deployment requests for a user group or department to which the user 102 belongs. Similarly, rather than provide the controls 162 to approve or deny a deployment request, the user 102 can be provided controls to cancel the deployment or edit the data packages or change which destination computing environments are specified. The interfaces provided to both the user 102 and the 106 can both provide up-to-date status information about the sets of deployment requests that their respective permissions enable them to view. This status information can include current status and in many cases includes real-time or near-real-time measures of completion for deployments in progress.

Referring to FIG. 1B, in stage (F), the user 106 interacts with the user interface 160 to select the user interface control 162 to approve the requested deployment of the data package 124 to the computing environment 140b. As a result, the client device 108 sends approval data 163 to the computer system 110 that triggers the deployment of the data package 124 to the destination computing environment 140b as the user 102 requested. As will be discussed further below, the interface 160 can provide the user 106 additional tools to view, edit, validate, and test data packages before approving deployment, after which the computer system 110 automatically orchestrates the operations needed to carry out the approved deployment.

In stage (G), the computer system 110 begins the deployment of the data package 124 to the destination computing environment 140b, as approved by the user 106. This includes the computer system 110 causing the data package 124 to be transferred from the repository 120 in cloud computing storage to the computing environment 140b over the network 130, and for the computing environment 140b to receive and incorporate the contents of the data package 124.

The computer system 110 can cause the deployment of the data package 124 in any of various ways. As an example, the computer system 110 can retrieve the data package 124 and cause changes to the computing environment 140b, such as to transfer files, change settings, and otherwise push changes to the computing environment 140b. For example, in a containerized computing environment, the computer system 110 may alter the container for the computing environment 140b or alter a software image or state data for the container. As another example, the computer system 110 may communicate with the computing environment 140b to cause the computing environment 140b to retrieve the data package 124 directly from the repository 120 and make changes based on the contents of the data package 124. In this manner, the computer system 110 can instruct the computing environment 140b to pull the data package 124 from the repository 120 and to perform the changes or installation operations specified in the data package 124 or in another set of instructions the computer system 110 provides.

In general, deployment of a package can include several changes to the destination computing environment. For example, files in the package 124 can be copied into the computing environment 140b, with names and file system locations as specified in the package 124. In addition, metadata and configuration settings specified by the package 124 can be transferred into the computing environment 140b. In some implementations, software components of the computing environment 140b are updated, or software installers are run, to update software of the computing environment 140b. If connections or permissions are needed to access additional servers or externally-hosted databases and datasets, these additions can also be made.

In stage (H), the computer system 110 updates its records to note the approval of the deployment request and the change in status of the deployment requests. For example, the computer system 110 can record the user that approved the request (e.g., the user 106), the time that approval was given, the time the deployment began, and so on. As a result, the status also changes from pending-unapproved, to pending-approved, to in progress, and so on, until the deployment reaches a status of being completed. In the illustrated example, the computer system 110 removes the deployment request from the queue 112 of deployment requests needing action after the deployment request has been approved.

In stage (I), the computer system 110 provides status updates 171, 172 to the client devices 104, 108 to show the changes in status of the deployment request. As the status changes, the computer system 110 can provide notifications to the users 102, 106, or may update the status shown on a deployment status dashboard interface for the users 102, 106. For example, this can be shown as an indication in the interface 160 that the approved deployment request is in progress, and then that it has been completed (not illustrated in FIG. 1B). As another example, the status update can be provided as a notification message or alert 173, as indicated on the interface 150, to inform the user 102 that requested the deployment that the requested action has been performed.

As shown in FIGS. 1A-1B, the computer system 110 provides significant versatility to allow a wide range of users to create and request deployment of customized packages of objects, while preserving the security of shared enterprise computing environments. The cloud-based repository 120 for data packages provides the ability to set a custom scope of availability and permissions for packages as needed, making data packages available to individual users, groups of users, departments, or an organization as a whole. The repository 120 also allows for efficient selective reuse of data packages across computing environments and by different groups of users, all from remotely accessible, Internet-based management interfaces. Many types of users, including data architects, data analysts, and administrators can view the status of the deployment requests that they are associated with and which are viewable given their roles and permissions in the system.

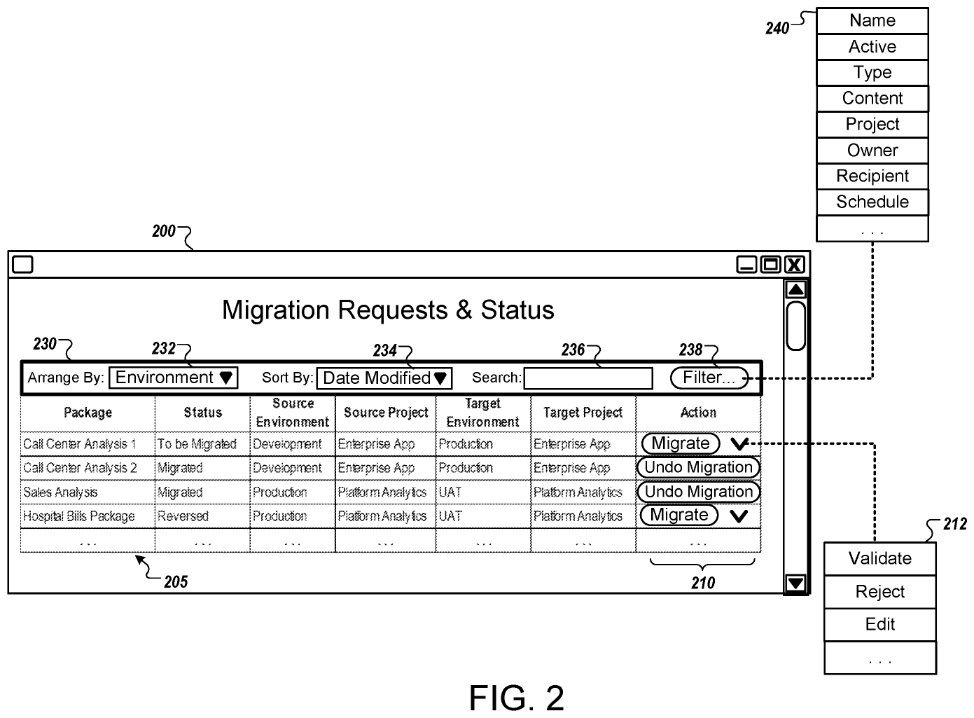

FIG. 2 is diagram illustrating an example of a user interface 200 for managing object migration among computer environments. The user interface 200 shows in greater detail the type of interface 160 of FIGS. 1A-1B. The user interface 200 is configured so that an administrator can view and act on requests to deploy different packages of objects to various computing environments. The user interface 200 shows a list 205 of migration requests, and information for each migration request including the name of the package, status of migration, the source computing environment, the source project, the destination or target environment, and the destination or target project. The user interface 200 also provides controls 210 that enable the administrator to take action for each individual request, for example, to perform the requested deployment or migration (e.g., to approve the request and start deployment), to validate the package, to reject the migration request, to view the contents of the package, to edit the package, to undo or reverse a previously-performed deployment, to cancel a deployment in progress, to re-use or re-create a package or request (e.g., as a base package for making further changes or to direct the package to an additional target environment), delete a package (e.g., from the repository), and so on. In the example, the controls 210 are shown as buttons for specific actions, with a drop-down list that can show multiple selectable options 212 when a user interacts with one of the controls 210.

The user interface 200 also includes controls 230 for arranging the display of packages and migration requests. For example, the controls 230 include a drop-down control 232 for grouping or sorting the packages and requests, e.g., by source environment, by source project, by target environment, by target project, by migration status, etc. In addition, the controls 230 include a drop-down control 234 to specify which criteria should be used to sort the list 205 of packages and requests, e.g., by package name, by migration status, by date created, by date modified, by size, etc. The controls 230 can include a search control 236, such as a text field to receive search query keywords for searching for packages and requests by package name, environment name, project name, and so on. The controls 230 can include a filter control 238 that enables the user to set a filter for the list 205, for example, to cause the list 205 to show only the packages or requests that satisfy the filter criteria. The filter control 238 can enable the user to select from any of various types of filters, e.g., to set filters by package name, status, type of package or migration, content of package, project involved, owner of the package (or project or environment), recipient, schedule, or based on other parameters. In setting filters, the control 238 may enable the user to set thresholds and other parameters, such as minimums, maximums, ranges, or other values used to define the set of packages or requests to view.

The computer system 110 can enable various different types of processing to validate a data package. For example, the computer system 110 can check references (e.g., links, URLs, file references, etc.) to make sure that they can be successfully resolved and accessed. If elements of the package make function calls to certain APIs or software modules, the computer system 110 can identify those function calls and verify that the destination computing environment provides access to them. More generally, the computer system 110 can identify the dependencies needed for elements of the package and determine whether those dependencies are satisfied by the contents of the package and/or the configuration of the destination computing environment. The computer system 110 can verify the contents of the package, to verify whether the package is complete and has not been tampered with. The computer system 110 can also verify the security of a data package, such as by checking whether signatures or hashes are valid for individual items in a package, for groups of items in a package, or for the package as a whole. The computer system 110 can check compatibility of the contents of the package with the software at the destination computing environment. For example, if elements of the package are designed to operate with a particular type of software or a particular version of an application, the computer system 110 can determine whether the needed software is present at the destination computing environment. Similarly, if the contents of the package use a particular file type or data encoding, the computer system 110 can verify whether the destination computing environment has the capability to open and use the contents of the package. In some implementations, the computer system 110 can determine whether the destination computing environment has appropriate permissions or access authorization to perform operations that the package or particular elements of the package interact with. For example, if a document in a package relies on access to a database system, the computer system 110 can determine whether the destination computing environment has access to that database system.

If the validation processes performed by the computer system 110 determine that a package is complete and compatible with the destination computing environment, the computer system 110 indicates the successful validation result in the user interface 100. If validation processing identifies problems with the package (e.g., incompatibility with the destination computing environment, missing dependencies, etc.), the computer system 110 can notify the user using the interface 200. The computer system 110 can attempt to correct problems with a package, such as by converting files to a compatible encoding or file type, substituting a compatible software module or version for an incompatible one, adding dependencies, and so on. The computer system 110 may take these actions automatically, or may propose changes to the package that the user can view and approve one-by-one or as a group using the interface 200.

FIGS. 3A-31 are diagrams illustrating examples of user interfaces for creating object packages and for requesting and managing deployment of object packages.

FIG. 3A shows a user interface 300 that can be provided to any of various users of the system 100. For example, the user interface 300 can be provided to the user 102 as an example of the interface 150 shown in FIG. 1A. The user interface 300 is used to create a package of objects which can be used to initiate a deployment or migration to a different computing environment.

The user interface 300 includes two main tabs that show different views, an objects tab 301 for selecting and managing objects to include in a package and a summary tab 302 that shows a summary of the package as defined by the currently-selected options. In the objects tab 301, the user interface 300 provides an input field 303 to specify a name for the package. The objects tab view also includes a target area 307 where the user 102 can drag and drop items to include in the package being created. The user 102 may additionally or alternatively select objects to include in the package being created by clicking the add objects button 306 or clicking in the target area 307. The objects tab view also includes a search control 304 enabling a user to submit a search query to search within the set of objects that have been selected. In addition, a filter control 305 enables the user 102 to specify filters for a focusing or limiting the information presented.

The objects tabs 301 also includes a cancel control 308 that the user 102 can select to end the process of creating the package and discard the items selected. The objects tab 301 includes a create control 309 that, when selected, triggers the computer system 110 to create the data package that the user 102 has defined.

FIG. 3B shows an additional user interface 310 for selecting objects to include in the data package being created. For example, the user interface 310 can be presented after the user 102 interacts with the add objects button 306 or clicks or taps in the target area 307 shown in FIG. 3A. The user interface 310 includes a sidebar 312 with different categories of objects that the user can select to include in the data package. The categories of objects indicated in the sidebar 312, as well as the objects presented in the rest of the user interface 310, can be determined based on the permissions of the user 102, the contents of a personal library and set of projects for the user 102, and also the contents of any databases, repositories, projects, or other files that are associated with the role or group membership of the user 102. In some implementations, the user 102 is able to select from any of various file systems, databases, repositories, or other set of data that the user has access to in the enterprise system 100.

In the example, the sidebar 312 presents two main categories of objects, analysis, objects and modeling objects. The analysis objects include documents, cards, reports, and data sets. The modeling objects include schemas, attributes, metrics, formulas, calculations, custom groups, derived elements, drill maps, facts, filters, functions, and hierarchies. In the example, the user 102 has selected the documents category in the sidebar 312, and as a result, the region to the right includes a list 325 of documents. The interface 310 shows a column 316 for selecting items, a column 317 indicating the name of the documents, a column 318 to indicate which objects are certified, a column 319 to indicate the owner of the objects, a column 320 to indicate the date the object was created, and a column 321 to indicate a date that the object was modified. The user 102 selects two documents, shown as the set 324. After selecting documents using the interface 310, the user can select a control 322 to add the selected documents to the package being created. As another option, the user could cancel the selection with a cancel button 323.

FIG. 3C shows another interface 330 that can be provided to the user 102 to select a project for the package being created. The user interface 330 indicates that the selected objects are from different environments or projects. The interface invites the user 102 to select a project and an environment for the package. For example, the user interface 330 includes a drop-down control 332 allowing the user 102 to select from among the environments that the user 102 has permissions and access to interact with. The user interface also includes a list 334 of projects associated with the environment selected. For example, the user 102 has selected a project 336 called platform analytics, which is specified as the project for the package being created. The user 102 can then select the control 337 to designate the environment and project selected, or the user 102 can select a cancel button 338 to cancel the selection.

FIG. 3D shows another user interface 340 that the user 102 may use to initiate the creation of a new package. The user interface 340 shows a library view that displays documents, data sets, or other information that the user can access through the enterprise platform. The user can select one or more documents or other objects and then invoke a context menu 346 which has a selectable option 348 to create a new migration package. For example, the user 102 may select a set of documents 344 and then right click on the selected documents to invoke the context menu 346. By selecting the option 348, the user 102 can start the package creation process and be shown an interface such as the user interface 300 of FIG. 3A, but with the target area 307 already populated with the objects that have been selected.

As the various interfaces show, the system can provide multiple entry points to the functionality of defining migration packages. For example, the user 102 may invoke the package creation functionality from a menu, a context menu, a toolbar, by dragging and dropping objects to an icon or drop target, or in other ways.

FIG. 3E shows the user interface 300, updated to include the objects selected in FIG. 3D. For example, FIG. 3E can show the user interface 300 in a state that would be provided after the user 102 selects the option 348 in FIG. 3D. As illustrated, the user interface 300 has populated a region 350 with the set of objects that the user 102 had selected. The region 350 can describe various details about the selected objects, including a name, certification status, owner, date modified, and so on. The region 350 can also include controls to take action for an object, such as to replace an object, to convert the object to another format, to upgrade an object, to validate or test an object, and so on.

The user interface 300 also provides the ability to view relationships among objects. For example, an object such as Document 4 can have multiple related objects or dependencies needed for the main object to function. For example, Document 4 refers to or includes additional objects titled Visualization 1, Data Set A, and Filter Control B. The computer system 110 can use various techniques to identify the dependencies and include them in the package being created. For example, the computer system 110 can analyze the content of the object that the user selected to identify references to other objects. In addition, the computer system 110 can identify data types, data fields, and other values, and identify metadata that describes or characterizes those types of data or sources of data. Other techniques can also be used. For example, the computer system 110 can attempt to load or run an object, and can track the other components or resources that need to be accessed in order to do so.

The computer system 110 can include dependencies for each of multiple levels of objects. For example, a main object selected by a user, such as document 4, can have dependencies identified and selected by the computer system 110 and included in the package. In addition, the computer system 110 can analyze each of the dependencies found for Document 4 (e.g., Visualization 1, Data Set A, and Filter Control B), and can determine dependencies of these items. As a result, the computer system 110 may identify and include dependencies for multiple objects in a chain of related objects.

FIG. 3F shows the user interface 300 with an additional context menu 352. The context menu 352 includes an item 354 enabling the user 102 to specify for the computer system 110 to find and add dependencies. For example, the user 102 has selected the object labeled Document 5, and by right clicking or otherwise invoking the context menu 352, The user 102 is presented the option 354 to add dependencies of the Document 5 object. This interaction by the user can trigger the computer system 110 to run dependency check analysis and update the set of objects included in the package as well as update the interface in the user interface 300 to show the additional objects and relationships.

FIG. 3G shows another user interface 360 that can be presented to the user 102 customize the types of items that are found and included in a package. Among modeling items, examples of the types of dependencies include dossiers documents, information cards, reports, and data sets. For analytics items, examples of dependencies include attributes, base formulas, consolidation elements, custom groups, and derived elements. The user 102 may use the interface 360 to set a preference for the types of dependencies that the computer system 110 will find and include.

FIG. 3H shows another view of the user interface 300, this time with the summary tab 302 selected. With this view, the user 102 is shown information about the combined set of objects and settings and contents of the package being created. For example, and information section 371 indicates the environment selected by the user 102, the project selected by the user, the name of the user creating the package, and the size of the package. Another section 372 shows a breakdown of the number of objects and types of objects included in the package defined by the user. The interface 300 also includes more detailed information 373 further breaking down the nature of objects according to their types. For example, the section 373 indicates that the 11 main objects selected by the user for inclusion include eight dossiers and three other documents. In addition, the section 373 indicates a breakdown of the dependencies, indicating that there are 3 data sets, 10 attributes, and 7 metrics included among the dependencies. Overall, the information in the summary tab view provides the user 102 the chance to verify the contents of the package and confirm the important details that characterize the package that has been defined.

When the user 102 is satisfied with the package, the user 102 can interact with the button 309 to cause the computer system 110 to create the package as specified through the interfaces discussed above.

FIG. 3I shows a user interface 380 to show the user 102 information about packages and migration requests that the user 102 has made. The user interface 380 has many features that are similar to the user interface 200 of FIG. 2, but is focused on a more limited set of packages and migration requests and shows the view for a user 102 that does not have authorization to actually perform migrations. Although the user 102 is able to create packages of objects using the interfaces shown in FIGS. 3A-3H, The user 102 is only able to request migration which needs to be further approved by an authorized administrator.

The interface 380 includes controls 230 as discussed above, such as to specify how to group packages and migration requests and how to sort packages and migration requests, as well as features for searching and filtering. The user interface 380 shows a list of packages created by the user 102 or within the user's scope of authorization to view. Initially, when a package is first created, a target environment and target project may not be specified yet. For example, the first item in the list 382 can represent the package created based on the information in the summary view shown in FIG. 3H. When the user 102 selects one of the controls 384 for acting on this package, the user interface may provide the additional interface 390 for selecting a target environment and target project in which to deploy the package. As a result, the user 102 can complete the deployment request with the interface 390 by selecting an environment using an environment selection control 391 and selecting a project from a list of projects 391 when the user completes the request by selecting the request button 394, the computer system enters the request (such as in a migration queue 112 as discussed in FIG. 1A, or in other records) and causes the new migration request to be indicated to the appropriate administrator 106.

Similar to the interfaces provided to administrators, the interface 380 provided to users generally can include status information about packages and migration requests. Although, the scope of information provided in the interface 380 is limited to packages and migration requests that the user 102 has access to view, the status information for these items is provided (e.g., package created, migration requested, request approved, request denied, migration and progress, completion percentage 62%, migration completed, migration reversed, etc.). As a result, when users across the system 100 create packages and request migrations, they can each track the status of and confirm completion of deployments that they request.

In some implementations, other action controls 384 can be provided so that users can take other actions with respect to their packages and/or migration requests. For example, the controls 384 may be provided to enable a user to edit a created package, reuse an existing package to migrate to an additional environment, change a target environment or target project specified for a pending migration, upgrade and item within a package (e.g., to a more recent version) before or after requesting migration, and so on. As a result, the interface 380 and the other interfaces discussed herein provide users a high degree of versatility to specify customized deployments of interrelated sets of objects, often from multiple different sources or source environments and projects, and to efficiently assign the packages for deployment to specific target competing environments.

In the various interfaces discussed above, the interfaces can be tailored for the permissions and access authorization of the user. For example, if the user does not have permissions to be able to initiate a migration, then the interface can omit the “migrate” button and include instead a “request migration” button that, when selected, causes the migration to be added to a queue or list for approval by an administrator.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
providing, by the one or more computers, a first interface for defining packages of data objects;
receiving, by the one or more computers, input data from a first user through the first interface, wherein the input data specifies (i) data objects to include in a first data package, and (ii) a destination computing environment to receive the first data package;
generating, by the one or more computers, the first data package and storing the first data package in a repository in cloud computing data storage;
providing, by the one or more computers, a second interface for monitoring and acting on requests to deploy data packages to computing environments; and
in response to receiving approval from a second user through the second interface to deploy the first data package to the destination computing environment, causing, by the one or more computers, the first data package to be retrieved from the repository in cloud computing data storage and to be deployed to the destination computing environment.

2. The method of claim 1, wherein providing the first interface comprises providing an application programming interface (API) or providing user interface data for a user interface presented at a client device of the first user; and
wherein providing the second interface comprises providing an API or providing user interface data for a user interface presented at a client device of the second user.

3. The method of claim 1, wherein generating the first data package comprises:
retrieving the data objects indicated through the first interface from one or more repositories or source computing environments;
identifying a second data objects as dependencies of the data objects;
based on identifying the second data objects as dependencies of the data objects, retrieving the second data objects; and
generating the first data package to include the retrieved data objects indicated through the first interface and the retrieved second data objects.

4. The method of claim 1, comprising maintaining a records of package deployment requests and storing, for each migration request, an indication of a data package to be deployed, a target computing environment to receive the data package, an identifier for a user that requested deployment of the data package to the target computing environment, and a status of the requested deployment.

5. The method of claim 4, wherein providing the second interface comprises providing user interface data listing deployment requests initiated by different users and current status of each of the deployment requests, wherein a list of deployment requests is presented with user interface controls for the second user to select whether to approve or deny the deployment requests.

6. The method of claim 4, wherein providing the second interface comprises providing indications of current status of each of multiple deployment requests, including a measure of completion of at least one deployment in progress.

7. The method of claim 4, wherein providing the second interface comprises providing user interface data indicating a completed deployment request that has been fulfilled by deployment of a particular data package to a particular computing environment, the completed deployment request being presented with one or more user interface controls that are selectable by the second user to cause the one or more computers to reverse the deployment of the particular data package to the particular computing environment.

8. The method of claim 1, wherein the first user and the second user are assigned different permissions for managing deployment of packages, wherein the first user has permissions to create data packages and request deployment of data packages but not to perform deployment of data packages, and wherein the second user has increased permissions that include authorization to view and approve or deny deployment requests made by other users, wherein content provided through the first interface and the second interface is determined based on the respective permissions of the first user and the second user.

9. The method of claim 1, wherein the first user and the second user are assigned different permissions for managing deployment of packages, wherein the first user has permissions to view deployment requests by the first user and status of the deployment requests by the first user but not to view deployment requests by other users, and wherein the second user has increased permissions that include authorization to view and approve or deny deployment requests made by other users, wherein content provided through the first interface and the second interface is determined based on the respective permissions of the first user and the second user.

10. The method of claim 1, wherein providing the second interface comprises providing a validation control that is selectable by the second user to initiate validation analysis for the first data package;
wherein the method comprises:
receiving input data indicating selection of the validation control by the second user;
in response to receiving the input data, assessing compatibility of the first data package with the destination computing environment; and
providing, through the second interface, results of assessing the compatibility of the first data package with the destination computing environment.

11. A system comprising:
one or more computers; and
one or more computer-readable media storing instructions that are operable, when executed by the one or more computers, to cause the one or more computers to perform operations comprising:
providing, by the one or more computers, a first interface for defining packages of data objects;
receiving, by the one or more computers, input data from a first user through the first interface, wherein the input data specifies (i) data objects to include in a first data package, and (ii) a destination computing environment to receive the first data package;
generating, by the one or more computers, the first data package and storing the first data package in a repository in cloud computing data storage;
providing, by the one or more computers, a second interface for monitoring and acting on requests to deploy data packages to computing environments; and
in response to receiving approval from a second user through the second interface to deploy the first data package to the destination computing environment, causing, by the one or more computers, the first data package to be retrieved from the repository in cloud computing data storage and to be deployed to the destination computing environment.

12. The system of claim 11, wherein providing the first interface comprises providing an application programming interface (API) or providing user interface data for a user interface presented at a client device of the first user; and
wherein providing the second interface comprises providing an API or providing user interface data for a user interface presented at a client device of the second user.

13. The system of claim 11, wherein generating the first data package comprises:
retrieving the data objects indicated through the first interface from one or more repositories or source computing environments;
identifying a second data objects as dependencies of the data objects;
based on identifying the second data objects as dependencies of the data objects, retrieving the second data objects; and
generating the first data package to include the retrieved data objects indicated through the first interface and the retrieved second data objects.

14. The system of claim 11, wherein the operations comprise maintaining a records of package deployment requests and storing, for each migration request, an indication of a data package to be deployed, a target computing environment to receive the data package, an identifier for a user that requested deployment of the data package to the target computing environment, and a status of the requested deployment.

15. The system of claim 14, wherein providing the second interface comprises providing user interface data listing deployment requests initiated by different users and current status of each of the deployment requests, wherein a list of deployment requests is presented with user interface controls for the second user to select whether to approve or deny the deployment requests.

16. One or more non-transitory computer-readable media storing instructions that are operable, when executed by one or more computers, to cause the one or more computers to perform operations comprising:
providing, by the one or more computers, a first interface for defining packages of data objects;
receiving, by the one or more computers, input data from a first user through the first interface, wherein the input data specifies (i) data objects to include in a first data package, and (ii) a destination computing environment to receive the first data package;
generating, by the one or more computers, the first data package and storing the first data package in a repository in cloud computing data storage;
providing, by the one or more computers, a second interface for monitoring and acting on requests to deploy data packages to computing environments; and
in response to receiving approval from a second user through the second interface to deploy the first data package to the destination computing environment, causing, by the one or more computers, the first data package to be retrieved from the repository in cloud computing data storage and to be deployed to the destination computing environment.

17. The one or more non-transitory computer-readable media of claim 16, wherein providing the first interface comprises providing an application programming interface (API) or providing user interface data for a user interface presented at a client device of the first user; and
wherein providing the second interface comprises providing an API or providing user interface data for a user interface presented at a client device of the second user.

18. The one or more non-transitory computer-readable media of claim 16, wherein generating the first data package comprises:
retrieving the data objects indicated through the first interface from one or more repositories or source computing environments;
identifying a second data objects as dependencies of the data objects;
based on identifying the second data objects as dependencies of the data objects, retrieving the second data objects; and
generating the first data package to include the retrieved data objects indicated through the first interface and the retrieved second data objects.

19. The one or more non-transitory computer-readable media of claim 16, wherein the operations comprise maintaining a records of package deployment requests and storing, for each migration request, an indication of a data package to be deployed, a target computing environment to receive the data package, an identifier for a user that requested deployment of the data package to the target computing environment, and a status of the requested deployment.

20. The one or more non-transitory computer-readable media of claim 19, wherein providing the second interface comprises providing user interface data listing deployment requests initiated by different users and current status of each of the deployment requests, wherein a list of deployment requests is presented with user interface controls for the second user to select whether to approve or deny the deployment requests.
